(19) United States
(12) Patent Application Publication
(10) Pub. No.: US 2016/0180572 A1
(43) Pub. Date: Jun. 23, 2016

(54) IMAGE CREATION APPARATUS, IMAGE CREATION METHOD, AND COMPUTER-READABLE STORAGE MEDIUM

(71) Applicant: CASIO COMPUTER CO., LTD., Tokyo (JP)

(72) Inventor: Yoshiharu Houjou, Tokyo (JP)

(21) Appl. No.: 14/927,019

(22) Filed: Oct. 29, 2015

(30) Foreign Application Priority Data
Dec. 22, 2014 (JP) 2014-259355

(51) Int. Cl. G06T 13/80; H04N 5/232; G06K 9/00

(52) U.S. Cl. CPC G06T 13/80; G06K 9/00302; G06K 9/00268; H04N 5/23219

(57) ABSTRACT

An image creation apparatus includes: an operation circuit, in which the operation circuit is configured to: specify an emotion of a subject from a face image of the subject derived from original image data; create a first image based on the face image; select a corresponding image that represents the emotion specified from among a plurality of corresponding images; and create a second image by combining the first image with the corresponding image selected.

### CROSS-REFERENCE TO RELATED APPLICATION

This application is based upon and claims the benefit of priority from the prior Japanese Patent Application No. 2014-259355, filed Dec. 22, 2014, and the entire contents of which are incorporated herein by reference.

### BACKGROUND OF THE INVENTION

1. Field of the Invention

The present invention relates to an image creation apparatus, an image creation method, and a computer-readable storage medium.

2. Related Art

Conventionally, there has been a technology for automatically creating a portrait from a picture. As in the technology disclosed in Japanese Unexamined Patent Application, Publication No. 2003-85576, there is technology for binarizing an image of a picture, rendering an image of a picture in a pictorial manner, and reproducing an original picture faithfully.

### SUMMARY OF THE INVENTION

However, in the abovementioned technology disclosed in Japanese Unexamined Patent Application, Publication No. 2003-85576, it simply reproduces the original picture faithfully and cannot create an expressive animation image newly from the original image.

The present invention was made by considering such a situation, and it is an object of the present invention to create an expressive animation image from an original image.

An image creation apparatus includes: an operation circuit, in which the operation circuit is configured to: specify an emotion of a subject from a face image of the subject derived from original image data; create a first image based on the face image; select a corresponding image that represents the emotion specified from among a plurality of corresponding images; and create a second image by combining the first image with the corresponding image selected.

### BRIEF DESCRIPTION OF THE DRAWINGS

FIG. 1 is a block diagram illustrating the hardware configuration of an image capture apparatus according to an embodiment of the present invention;

FIG. 2 is a schematic view illustrating an example of a flow of creating an animation image according to the present embodiment;

FIG. 3-A is a schematic view illustrating a creation method of an animation image according to the present embodiment;

FIG. 3-B is a schematic view illustrating a creation method of an animation image according to the present embodiment;

FIG. 3-C is a schematic view illustrating a creation method of an animation image according to the present embodiment;

FIG. 4 is a functional block diagram illustrating a functional configuration for executing animation image creation processing, among the functional configurations of the image capture apparatus of FIG. 1; and

FIG. 5 is a flowchart illustrating a flow of animation image creation processing executed by the image capture apparatus of FIG. 1 having the functional configuration of FIG. 4.

### DETAILED DESCRIPTION OF THE INVENTION

Embodiments of the present invention are explained below with reference to the drawings.

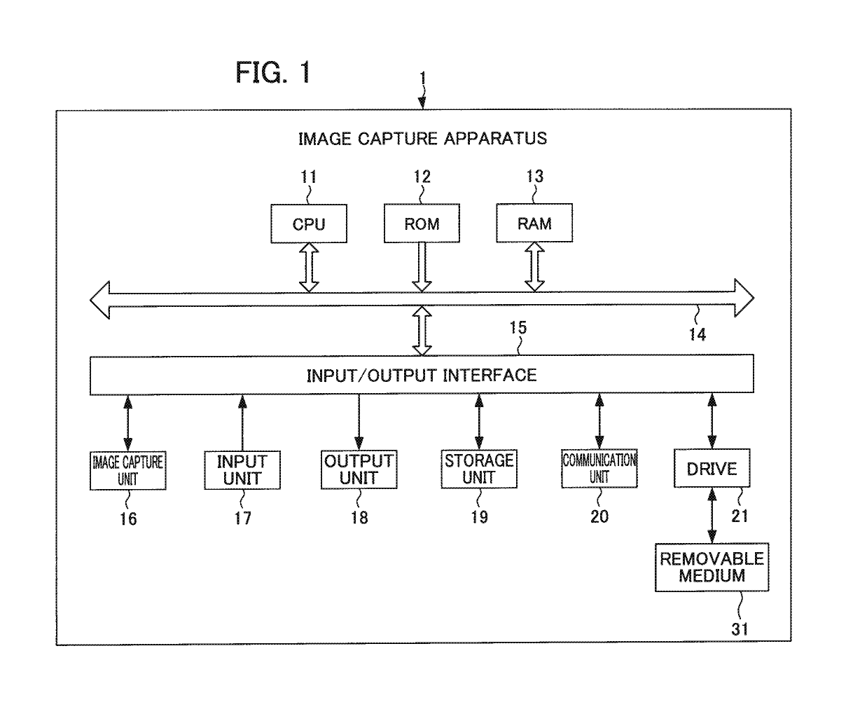

FIG. 1 is a block diagram illustrating the hardware configuration of an image capture apparatus according to an embodiment of the present invention.

The image capture apparatus 1 is configured as, for example, a digital camera.

The image capture apparatus 1 includes a CPU (Central Processing Unit) 11 which is an operation circuit, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor, which are not shown.

In order to photograph an object, the optical lens unit is configured by a lens such as a focus lens and a zoom lens for condensing light.

The focus lens is a lens for forming an image of an object on the light receiving surface of the image sensor.

The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of an object in the optoelectronic conversion device. The optoelectronic conversion device optoelectronically converts (i.e. captures) the image of the object, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, an image processing unit (not illustrated), and the like as appropriate.

The input unit 17 is configured by various buttons and the like, and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

The image capture apparatus 1 configured as above has a function of creating an animation image in which a human face is depicted as an animation from an image including a face of a human (subject) photographed. Furthermore, in the image capture apparatus 1, an animation image of a portion other than the face is created based on the facial expression of a human.

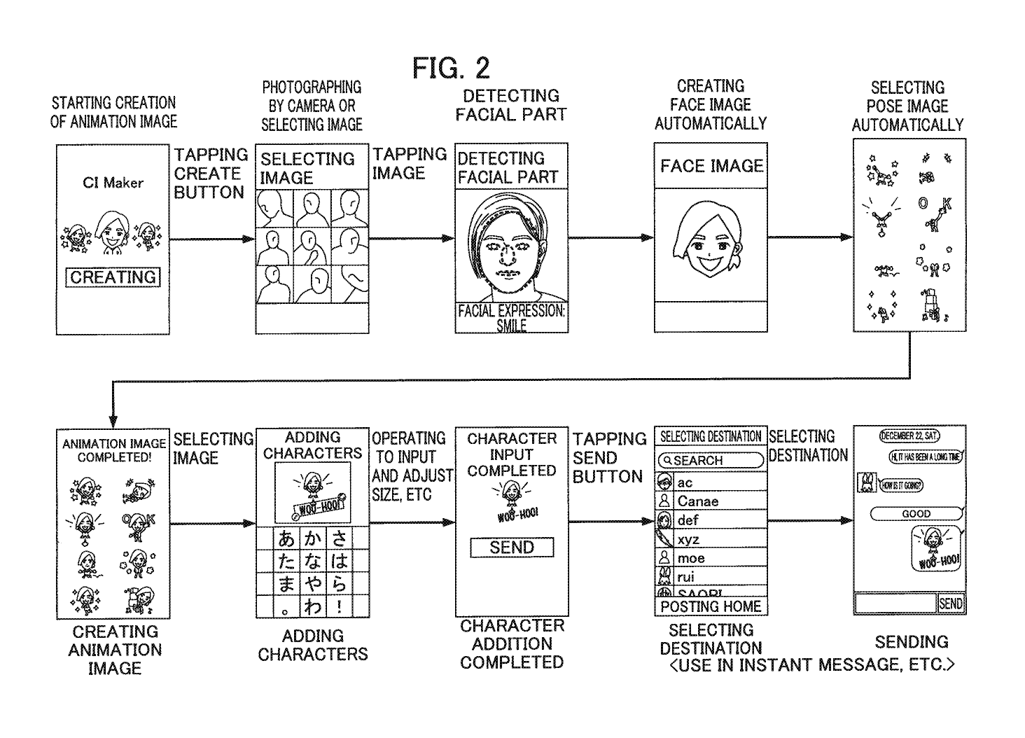

FIG. 2 is a schematic view illustrating an example of a flow of creating an animation image according to the present embodiment.

As illustrated in the example of FIG. 2, the animation image uses image data produced by performing photography with the image capture unit 16 as necessary. By either photographing by a camera or selecting image data stored in the storage unit 19, image data used in the creation of a face image (hereinafter, referred to as “original image data”) is designated. The original image data constitutes an image including a face of a subject (hereinafter, referred to as a subject image).

Then, analysis for facial recognition is performed on the original image data. As a result, a facial part of a subject (for example, a human face) and a facial expression are detected from a subject image.

Furthermore, a portrait conversion (animation conversion) is performed based on the facial part thus detected to automatically create a first image (hereinafter, referred to as “face image”) in which a real image of a person is made into animation (into a two-dimensional image).

Based on a facial expression detected from an analysis result of the facial recognition, a target image in which a body or an upper half of the body other than the face of a person is modified (hereinafter, referred to as “pose image”) is selected automatically. The pose image is an image including a posture, a behavior, or an action of a user (subject). For example, in a case of a facial expression detected being smile, a pose of holding up hands and a pose of jumping, for example, are included, as expressing a happy emotion.

Then, by combining the face image which is the first image created with the pose image selected, a second image in which a person is depicted as an animation (hereinafter, referred to as “animation image”) is created.

At this moment, in a case of adding a character on the animation image, an animation image is created by inputting a character, and adjusting the size and the angle of the character.

The finally created animation image is used as a message tool for conveying an emotion and the like intuitively in place of a text message in a chat, an instant message, a mail, and the like.

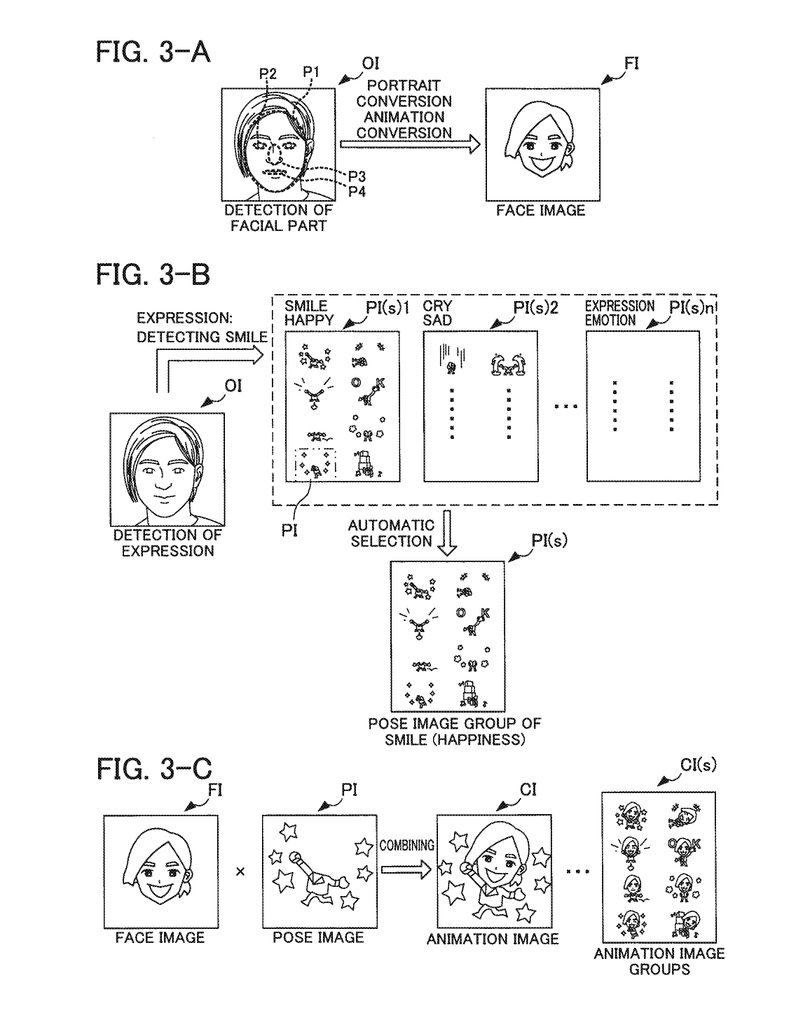

FIG. 3 is a schematic view illustrating a creation method of an animation image according to the present embodiment.

As illustrated in FIG. 3-A, a face image FI is automatically created based on facial parts P1 to P4 from a subject image OI. An existing technology of creating a face image is used for the technology of creating an animation image (two-dimensional image) by extracting a characteristic portion (facial part in the present embodiment) constituting an image from an image of a real picture. It should be noted that the amination image, which is a two-dimensional image, can be configured by, for example, a static image in which an illustration of an image of a face of a subject is drawn, a sequence of a plurality of static images that continuously changes, a moving image, etc.

Furthermore, as illustrated in FIG. 3-B, regarding the pose image PI in the present embodiment, a pose image group PI(s) is automatically selected that corresponds to an emotion represented by an expression detected from among pose image groups PI(s) 1, PI(s)2, and PI(s)n, which are organized for each emotion represented by facial expressions such as smile, cry, etc., based on a facial expression (for example, a smile expression) detected from a subject image OI.

Furthermore, as illustrated in FIG. 3-C, the animation image CI is created by combining the face image FI thus created with the pose image PI thus selected. Eventually, for the animation image, an animation image group CI(s) is automatically created for each pose image group PI(s) selected.

Therefore, in the present embodiment, since an animation image is created by combining a pose image corresponding to an emotion represented by a facial expression with a face image created based on a face, the animation image thus created reflects an emotion represented by a facial expression from both a face and a pose, which means that an emotion and the like are represented as the whole animation image, a result of which various kinds of images are acquired which express emotions and the like intuitively.

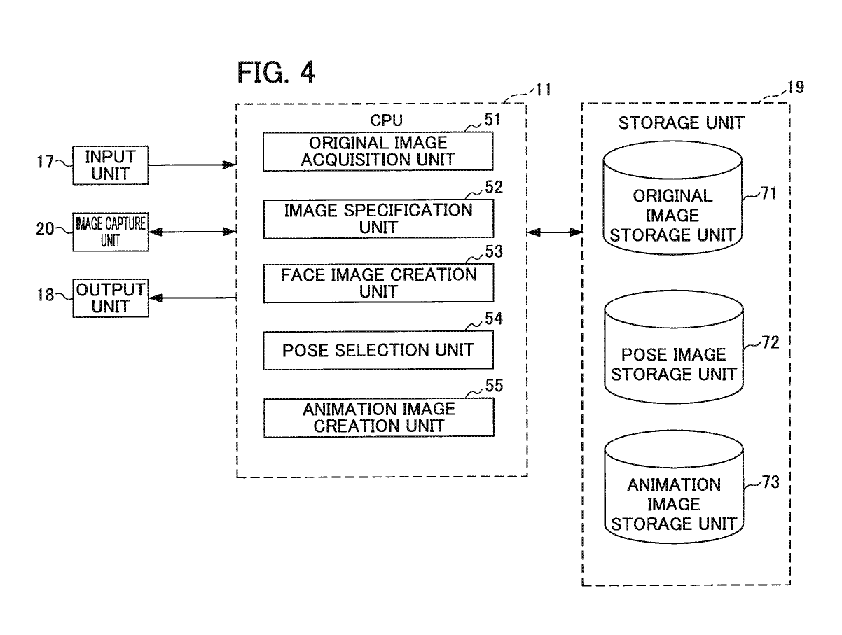

FIG. 4 is a functional block diagram illustrating a functional configuration for executing animation image creation processing, among the functional configurations of the image capture apparatus 1.

Animation image creation processing refers to a sequence of processing for creating an animation image based on the first image created based on a facial part specified from the original image data and an emotion represented by a facial expression specified from the original image data.

In a case of executing the animation image creation processing, as illustrated in FIG. 4, an original image data acquisition unit 51, an image specification unit 52, a face image creation unit 53, a pose selection unit 54, and an animation image creation unit 55 function in the CPU 11.

Furthermore, an original image data storage unit 71, a pose image storage unit 72, and an animation image storage unit 73 are established in an area of the storage unit 19.

In the original image data storage unit 71, for example, data of an original image is stored which is acquired externally via the image capture unit 16, the Internet, or the like, and used for specifying a facial expression and creating a first image which is a face image.

Data of a pose image which is associated with an emotion represented by a facial expression is stored in the pose image storage unit 72. As illustrated in FIG. 3-B, in the present embodiment, a plurality of pose images is organized in group units for each emotion represented by a facial expression. In other words, data of a plurality of pose images which express emotions indicated (represented) by user's facial expressions is grouped for each kind of emotions.

Data of an animation image created by combining a face image with a pose image is stored in the animation image storage unit 73.

The original image data acquisition unit 51 acquires image data from the image capture unit 16, an external server via the Internet, etc., or the original image data storage unit 71 as original image data that is the creation target of the animation image. In the present embodiment, the original image data acquisition unit 51 acquires image data stored in advance in the original image data storage unit 71 as the original image data.

The image specification unit 52 performs image analysis for facial recognition on the original image data acquired by the original image data acquisition unit 51 to specify facial parts in the image, as well as specifying the facial expression of a person. By specifying the facial expression, an emotion represented by the facial expression is specified.

It should be noted that various kinds of existing image analysis technologies for facial recognition are used for specifying the face of a human and a facial expression in an image.

The face image creation unit 53 performs a portrait conversion (animation conversion) based on a facial part specified by the image specification unit 52 to create a face image.

It should be noted that various kinds of existing portrait conversion (animation conversion) technologies are used for creating a two-dimensional face image from a real image.

The pose selection unit 54 selects a pose image corresponding to an emotion represented by a facial expression from among pose images stored in the pose image storage unit 72, based on the emotion represented by the facial expression specified by the image specification unit 52. In the present embodiment, the pose selection unit 54 selects a plurality of pose images corresponding to the emotion represented by the facial expression stored in the pose image storage unit 72.

The animation image creation unit 55 creates a single animation image by combining a face image created by the face image creation unit 53 with a pose image selected by the pose selection unit 54. In other words, the animation image creation unit 55 creates an animation image by combining the face image with a pose image of a body or an upper half of the body corresponding to an emotion represented by a facial expression in the face image.

Then, the animation image creation unit 55 stores the animation image thus created in the animation image storage unit 73.

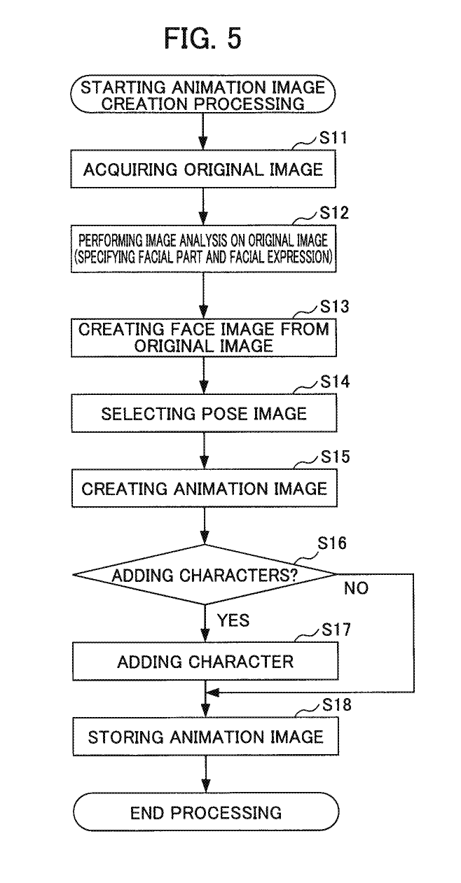

FIG. 5 is a flowchart illustrating the flow of animation image creation processing executed by the image capture apparatus 1 of FIG. 1 having the functional configuration of FIG. 4.

The animation image creation processing starts by a user's operation on the input unit 17 to start animation image creation processing.

In Step S11, the original image data acquisition unit 51 acquires an original image, which is a target for creating an animation image, from image data stored in the original image data storage unit 71. More specifically, as illustrated in FIG. 2, the original image data acquisition unit 51 acquires an image selected via the input unit 17 by the user from among a plurality of pieces of image data stored in the original image data storage unit 71, as original image data.

In Step S12, the image specification unit 52 performs image analysis on the original image data using analysis technology for facial recognition. As a result of the image analysis, a facial part and a facial expression of a person are specified. More specifically, as illustrated in FIG. 3-A, the image specification unit 52 specifies the facial parts P1 to P4, further specifies a facial expression of “smile”, and specifies an emotion (for example, happiness) represented by the facial expression of “smile”.

In Step S13, the face image creation unit 53 creates a face image by performing portrait conversion on the facial parts of the original image data specified by the image specification unit 52. More specifically, as illustrated in FIG. 3-A, the face image creation unit 53 performs portrait conversion on the facial parts P1 to P4 in the subject image OI to create the face image FI from the subject image OI.

In Step S14, the pose selection unit 54 selects a pose image corresponding to the emotion represented by a facial expression from among pose images stored in the pose image storage unit 72 based on the emotion represented by the facial expression specified by the image specification unit 52. More specifically, as illustrated in FIG. 3-B, the pose selection unit 54 selects the pose image PI corresponding to the emotion (happiness) represented by the facial expression of “smile” specified by the image specification unit 52.

In Step S15, the animation image creation unit 55 creates a single animation image by combining a face image created by the face image creation unit 53 with a pose image selected by the pose selection unit 54. More specifically, as illustrated in FIG. 3-C, the animation image creation unit 55 creates the animation image CI by combining the face image FI thus created with the pose image PI selected based on the emotion (happiness) represented by the facial expression of “smile”. By performing combination for all of the pose image groups PI(s) selected, the animation image groups CI(s) are created.

In Step S16, the animation image creation unit 55 judges whether there was an operation to add a character to the input unit 16.

In a case in which there is no operation to add a character, it is judged as NO in Step S16, and the processing advances to Step S18. The processing of Step S18 and higher is described later.

In a case in which there is an operation to add a character, it is judged as YES in Step S16, and the processing advances to Step S17. The processing of Step S18 and higher is described later.

In Step S17, the animation image creation unit 55 adds a character in an animation image. More specifically, as illustrated in FIG. 2, the animation image creation unit 55 adjusts the size and the angle of the character inputted via the input unit 16 by a user and performs adding a character into the animation image.

In Step S18, the animation image creation unit 55 stores the animation image thus created in the animation image storage unit 73, and then animation image creation processing ends.

As illustrated in FIG. 2, the animation image thus created is sent to a designated destination for images and used as an image expressing an emotion in an instant message, etc.

In a case of using a portrait image as an animation image used for SNS (Social Networking Service), etc., when there is an expression desired to be conveyed to some extent, conveying one's intention with an image expressing human emotions with less words is performed. Therefore, when creating a stamp, by either photographing an image including information relating to human emotions in advance or analyzing a picture of a face prepared in advance to classify a facial expression (emotions) using facial recognition technology to express the overall emotion, it is possible to create an animation image without a feeling of strangeness.

Therefore, with the image capture apparatus 1 according to the present embodiment, since a portion of a face and a portion other than the face are created based on an image designated by the user simply designating the image including the face of a person, it is possible to create an animation image easily since selection operations by the user of portions other than the face become unnecessary. Furthermore, since the animation image created in the image capture apparatus 1 according to the present embodiment is composed of a face image created from a picture of an actual face and a pose image corresponding to an emotion represented by a facial expression in the picture of the face, the image becomes an impressionable image that reflects expressions of emotions more intuitively.

The image capture apparatus 1 configured as mentioned above includes the original image data acquisition unit 51, the image specification unit 52, the face image creation unit 53, the pose selection unit 54, and the animation image creation unit 55.

The original image data acquisition unit 51 acquires original image data to be the target for processing.

The image specification unit 52 detects a face region from the original image data acquired by the original image data acquisition unit 51.

The face image creation unit 53 creates a face image which is a first image based on the face region detected by the image specification unit 52.

The image specification unit 52 specifies a facial expression in the face region from the original image data acquired by the original image data acquisition unit 51.

The pose selection unit 54 selects a pose image that is a corresponding image, based on the facial expression in the face region specified by the image specification unit 52.

An animation image, which is a second image, is created by combining the first image created by the face image creation unit 53 with the pose image that is a corresponding image created by the f pose selection unit 54.

With the image capture apparatus 1, since the face image that is the first image is created based on the facial expression in the face region, and the animation image that is the second image is created based on the facial expression in the face region, the first image is generated, and since the pose image that is a corresponding image is selected, it is possible to create an expressive animation image having a sense of unity as a whole from the original image.

The image specification unit 52 specifies a facial expression in a face region from the original image data acquired by the original image data acquisition unit 51.

The face image creation unit 53 creates a face image as a first image based on the face region detected by the image specification unit 52.

The image specification unit 52 specifies the facial expression based on a facial expression in the face region. Furthermore, by specifying the facial expression, an emotion represented by the facial expression is specified.

The pose selection unit 54 selects a pose image, which is a corresponding image that corresponds to an emotion represented by a facial expression and includes a portion other than the face, based on an emotion represented by the facial expression specified by the image specification unit 52.

The animation image creation unit 55 creates an animation image that is a second image, by combining a face image that is a first image, created by the first image creation unit 53, with a pose image that is a corresponding image selected by the pose selection unit 54.

With such a configuration, in the image capture apparatus 1, since the pose image selected is used based on the face image, which is the first image created from the face region and the emotion represented by the facial expression, the image becomes an impressionable image that reflects expressions of emotions more intuitively, and thus it is possible to create an expressive animation image.

Furthermore, the image capture apparatus 1 includes the pose image storage unit 72 that stores a pose image that is a corresponding image.

The pose selection unit 54 selects the pose image which is a corresponding image that is stored in the pose image storage unit 72, based on an emotion represented by a facial expression specified by the image specification unit 52.

With the image capture apparatus 1, since an animation image can thereby be created by simply selecting a pose image which is corresponding image that corresponds to an emotion represented by a facial expression prepared in advance, it is possible to perform creation of an animation image easily.

Furthermore, in the image capture apparatus 1, the pose image that is a corresponding image is an image including a human body other than a face.

With the image capture apparatus 1, since an image becomes an animation image including a portion other than a face, it is thereby possible to create an expressive animation image as a whole.

The image specification unit 52 specifies a facial expression by performing image analysis for facial recognition on an image of a face of a subject derived from original image data.

With the image capture apparatus 1, since a facial expression is specified using facial recognition, it is thereby possible to specify the facial expression in a more accurate manner. Therefore, it is possible to further improve the sense of unity between the face image which is the first image and the pose image as a whole.

Furthermore, in the image capture apparatus 1, original image data is image data in which a face is photographed.

The face image creation unit 53 creates a face image which is a first image from the original image data by way of portrait conversion.

With the image capture apparatus 1, since a face image, which is a first image, is created from portrait conversion using the image data in which a face is photographed as the original image data, it is thereby possible to create an image in which a real picture is depicted as an animation.

It should be noted that the present invention is not to be limited to the aforementioned embodiments, and that modifications, improvements, etc. within a scope that can achieve the objects of the present invention are also included in the present invention.

In the abovementioned embodiment, it may be configured, for example, so as to notify of facial expressions such as anger, smile, crying, etc., before photographing. In such a case, it may be configured so as to display a live view screen of a level meter for expressions (for example, in a bar-shape meter and in a diagram-like meter).

By notifying expressions before photographing as described above, it is possible to photograph with a facial expression of a face in a pose which is desired to be created before photographing.

Furthermore, although the animation image is created based on a facial expression (emotion) of a human face analyzed from an image in the present embodiment, the present invention is not limited thereto, and it may be configured so as to create an animation image based on information that can be produced by analyzing an image such as age, sex, etc.

Furthermore, although it is configured to create an animation image based on the facial expression (emotion) of a human face in the abovementioned embodiment, the present invention is not limited thereto, and it may be configured so as to create an animation image by specifying a state from an image including an animal of which a facial expression (emotion) can be detected or a subject that can be personified (for example, a car and a rock).

Furthermore, although the pose image is created by selecting a pose image which is stored in the pose image storage unit 72 in advance in the abovementioned embodiment, it may be configured so as to create a pose image each time when handling to correspond to a facial expression upon creating an animation image.

Furthermore, although the animation image is described as a static image in the abovementioned embodiment, it may be configured to display a plurality of images continuously so as to be an image having motion or a moving image.

Although the example in which the animation image created is used as a tool that conveys an emotion and the like in place of a text in an instant message, etc., is explained in the present embodiment, it may be configured, for example, to display the animation image in a sentence in a mail or use as data for producing a stamp in a stamp maker using image data.

In the aforementioned embodiments, explanations are provided with the example of the image capture apparatus 1 to which the present invention is applied being a digital camera; however, the present invention is not limited thereto in particular.

For example, the present invention can be applied to any electronic device in general having an animation image creation processing function. More specifically, for example, the present invention can be applied to a laptop personal computer, a printer, a television receiver, a video camera, a portable navigation device, a cell phone device, a smartphone, a portable gaming device, and the like.

Furthermore, a plurality of first images may be created from a single piece of original image data. The plurality of first images may share the same face images or may have different face images, respectively, or some of them may share the same face images and some of them may have different face images. The plurality of first images is acceptable so long being images of a face that expresses an emotion represented by a facial expression specified by the image specification unit 52. It is possible to create an animation image which is a second image by combining this plurality of first images with a plurality of corresponding images (pose images).

The processing sequence described above can be executed by hardware, and can also be executed by software.

In other words, the hardware configurations of FIG. 4 are merely illustrative examples, and the present invention is not particularly limited thereto. More specifically, the types of functional blocks employed to realize the above-described functions are not particularly limited to the examples shown in FIG. 4, so long as the image capture apparatus 1 can be provided with the functions enabling the aforementioned processing sequence to be executed in its entirety.

A single functional block may be configured by a single piece of hardware, a single installation of software, or a combination thereof.

In a case in which the processing sequence is executed by software, the program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, ROM in which the program is recorded or a hard disk, etc. included in the storage unit.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image creation apparatus comprising:
an operation circuit,
wherein the operation circuit is configured to:
specify an emotion of a subject from a face image of the subject derived from original image data;
create a first image based on the face image;
select a corresponding image that represents the emotion specified from among a plurality of corresponding images; and
create a second image by combining the first image with the corresponding image selected.

2. The image creation apparatus according to claim 1,
further comprising a corresponding image storage unit that stores the plurality of corresponding images,
wherein the operation circuit selects a corresponding image that matches an emotion specified from the face of the subject from among the plurality of corresponding images stored in the corresponding image storage unit.

3. The image creation apparatus according to claim 2,
wherein a corresponding image group produced by grouping the plurality of corresponding images for each kind of emotion is stored in the corresponding image storage unit, and
wherein the operation circuit selects a plurality of corresponding images included in the corresponding image group which corresponds to the emotion specified, creates a plurality of the first images, combines the plurality of corresponding images selected with the plurality of first images, and creates a plurality of the second images.

4. The image creation apparatus according to claim 1,
wherein the operation circuit combines a character image with the second image.

5. The image creation apparatus according to claim 1,
wherein the corresponding image is an image including a human body other than a face.

6. The image creation apparatus according to claim 1,
wherein the corresponding image is an image that represents a posture or a behavior of a person.

7. The image creation apparatus according to claim 1,
wherein the first image is an image in which an image of the face of the subject is made into animation.

8. The image creation apparatus according to claim 7,
wherein the first image is configured by a static image or a moving image of a face of a subject.

9. The image creation apparatus according to claim 1,
wherein the operation circuit creates the first image from the original image by way of portrait conversion.

10. An image creation method used by an image creation apparatus comprising the steps of:
specifying an emotion of a subject from a face image of the subject derived from original image data;
creating a first image based on the face image;
selecting a corresponding image that represents the emotion specified from among a plurality of corresponding images; and
creating a second image by combining the first image with the corresponding image selected.

11. A non-transitory storage medium encoded with a computer-readable program used by an image creation apparatus that enables a computer to execute processing of:
specifying an emotion of a subject from a face image of the subject derived from original image data;
creating a first image based on the face image;
selecting a corresponding image that represents the emotion specified from among a plurality of corresponding images; and
creating a second image by combining the first image with the corresponding image selected.
